(19) United States
(12) Patent Application Publication
(10) Pub. No.: US 2003/0223120 A1
(43) Pub. Date: Dec. 4, 2003

(54) Lenticular display unit

(75) Inventors: Kwong Tak Li, Hong Kong (HK); Yat Fung Leung, Hong Kong (HK); Chun Hung Lee, Hong Kong (HK); Sai Fun Mak, Hong Kong (HK)

Correspondence Address: Richard P. Berg, Esq., c/o LADAS & PARRY, Suite 2100, 5670 Wilshire Boulevard, Los Angeles, CA, 90036-5679, US

(73) Assignee: HONORWAY CORPORATION LIMITED

(21) Appl. No.: 10/214,686

(22) Filed: Aug. 7, 2002

(30) Foreign Application Priority Data
May 28, 2002 (CN) 02103945.8
Jun. 5, 2002 (CN) 02236549.4

(51) Int. Cl. G02B 27/10

(52) U.S. Cl. 359/619

(57) ABSTRACT

The invention comprises a display unit for displaying at least two consecutive images to be viewed by a viewer. The unit comprises,

a housing having at least two wall portions defining a cavity therebetween. At least part of one of said wall portions is made of an array of linear lenses having a lenticular front face and a flat rear face.

At least one carrier is provided within the cavity.

The carrier is able to receive in use a substantially planar display member,

and pressure means are provided to urge the display member against the lens when a display member is within the cavity.

### FIELD OF THE INVENTION

This invention relates to a display unit and in particular relates to a display unit which is able to display two or more changing images which are able to be viewed through a lens in the display unit.

### BACKGROUND OF THE INVENTION

Display units which display multiple images are known in the market but these are unable to show detailed pictures and writing in relatively small fonts owing to their low resolution and the poor registration between the display card or other display member and the lens through which the images are viewed.

### OBJECT OF THE INVENTION

It is therefore an object of the present invention to provide a display unit which will obviate or minimise the foregoing disadvantage in a simple yet effective manner or which will at least provide the public with a useful choice.

### SUMMARY OF THE INVENTION

Accordingly the invention consists in a display unit for displaying at least two consecutive images to be viewed by a viewer, said unit comprising:

a housing having at least two wall portions defining a cavity therebetween, at least part of one of said wall portions being made of an array of linear lenses having a lenticular front face and a flat rear face;

at least one carrier within the cavity, the carrier being able to receive in use a substantially planar display member,

and pressure means to urge the display member against the lens when a display member is within the cavity.

Preferably the pressure means includes a plurality of rollers and biasing means to bias the rollers such that the display member is urged against the lens.

Preferably the pressure members bear on the display member.

Alternatively the display unit further includes a plate is provided within the cavity, the pressure member bearing on the plate which in turn bears on the display member.

Preferably the display unit further includes a substantially transparent support sheet positioned substantially against the face of the lenticular lens outward facing with respect to the housing.

Preferably the lenticules in the lenticular lens provide at least 15 lenticules per inch.

Preferably the display unit has at least 20 lenticules per inch.

Preferably the display unit has at least 30 lenticules per inch.

Preferably the display unit further includes adjustment means to enable the lens to be moved relative to the display member.

Preferably the adjustment means is operable from outside the casing.

Preferably the adjustment means includes a pivot on which the lens is mounted and the adjustment means is operable to rotate the lens about the pivot.

Preferably the display unit further includes movement means operable to cause relative movement substantially in their planes between the lens and the display member.

Preferably guiding means are provided to maintain the lens and display member in a substantially parallel relationship during relative movement of the lens and display member.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawings in which,

FIG. 1 indicates the difference in resolution between a lens having ten lenticules per inch when compared to a lens having thirty lenticules per inch.

FIG. 2 is a diagrammatic cross-sectional view of a display unit according to one preferred form of the invention,

FIG. 3 shows an adjustment device for use in the construction of FIG. 2 in elevation,

FIG. 4 is a plan view of the construction of FIG. 3,

FIG. 5 shows the effect of non-alignment between the picture and the lenticules showing non-alignment on the left-hand picture and substantially accurate alignment in the right-hand picture,

FIG. 6 shows a device which covers the group of black lines,

FIG. 7 illustrates a driving mechanism for use in the construction of FIG. 2,

FIG. 8 shows a gear box which can be used in the construction of FIG. 2,

FIG. 9 shows a cam arrangement for use in moving a display member or picture in the device of FIG. 2,

FIGS. 10 to 13 show a 3D effect due to motion in the construction,

FIG. 14 shows venting holes in the frame of a housing used in the construction of FIG. 2 to allow air movement,

FIG. 15 shows an alternative display unit in exploded form,

FIG. 16 shows a picture moving mechanism for use in the construction of FIG. 15,

FIG. 17 is a cross-sectional view of the construction of FIG. 16,

FIG. 18 shows access to the construction of FIG. 15 and FIG. 16 to enable a display member to be replaced, and

FIG. 19 shows a side elevation illustrating the arrangement of FIG. 18.

### DESCRIPTION OF THE PREFERRED EMBODIMENT

Referring now to the drawing, a display unit is provided as follows.

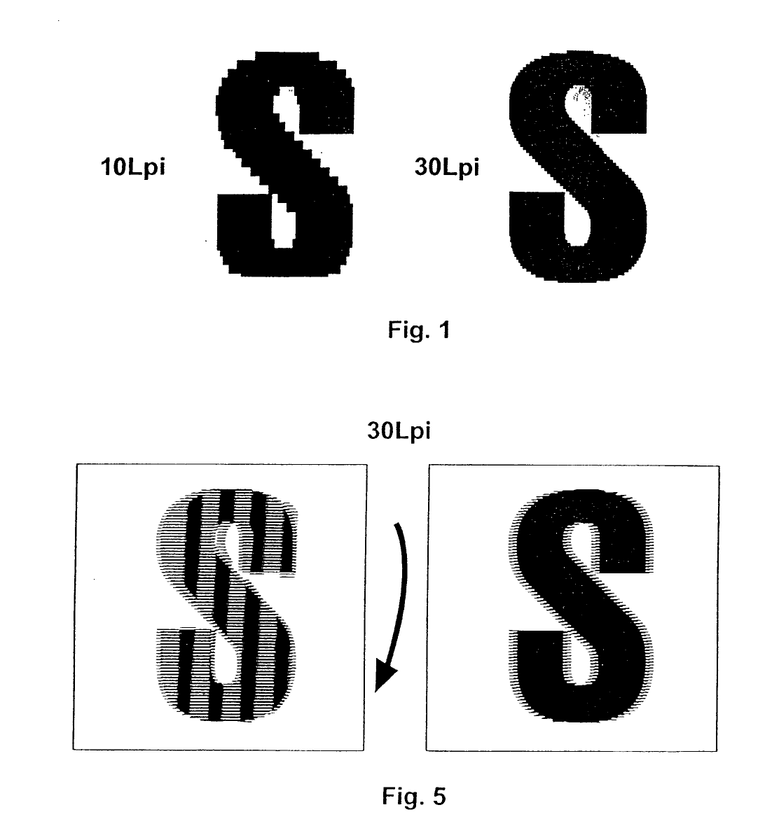

In FIG. 1 a pair of indicia are shown. Each of these indicia represent the letter “S”. The figure on the left-hand side is shown at ten lenticules per inch and the figure on the right-hand side at thirty lenticules per inch. As can be seen the fineness, or number of lenticules per inch, has a substantial effect on the clarity of the image. The higher the number of lenticules then the clearer the image. However the provision of a high number of lenticules per inch demands substantially enhanced registration between the display member or picture and the lenticular lens. In particular there must be a high degree of contact between the back of the lens and the display member to prevent the picture being out of focus and the picture and lens must be substantially parallel or the image will be substantially destroyed.

In order to achieve such a construction in one embodiment the construction of FIG. 2 is provided.

In this construction a housing 1 is provided by a perimeter frame 2. The housing 2 provides a cavity into which the following elements are provided. A lenticular lens 3 is provided along with a display member which may be in the form of a picture 4, which will be described further hereinafter. The picture 4 is placed closely adjacent the inwardly facing face of the lenticular lens 3.

In the embodiment of FIG. 2 a plate 5 is provided which is preferably a sliding plate. Between the sliding plate 5 and the picture 4 may be provided a layer of compressible material such as, for example, a sponge foam layer.

Pressure members are provided to urge the picture 4 against the lens 3. In this embodiment the pressure members comprise rollers 8 which are mounted in a suitable carrier 9, any suitable number of rollers may be provided, there being, for example, four or six such rollers. The rollers are urged against the plate 5, for example, by a compression spring 10 contained within a cylinder 11 mounted to a backing plate 12 engaged with the perimeter frame 2.

Also contained within the housing is a suitable light source 22. The lenticular lens 3 is held within the perimeter frame 2, for example, by suitable clamps 23.

In order to reduce and, if possible, prevent distortion of the lens and picture due to the pressure of the springs 10 and rollers 9, a substantially transparent front plate in the form of a clear panel 24 is provided. This may be formed, for example, from acrylic sheet. The acrylic sheet is made to any desired thickness, for example, in excess of 5 mm. The sponge layer assists the close contact of the picture 4 to the lens 3 and this may be, for example, 2 mm to 6 mm thick at a density of 6 kg to 25 kg per cubic metre. The sponge layer also has the effect of reducing the force between the picture and the lens to the minimum required to achieve the desired result.

In terms of the number of lenticules provided in the lens 3 it is envisaged that for example, where a relatively small display is required, for example, in the range six inches by seven inches to eight inches by twelve inches, substantially thirty lenticules per inch may be provided. For larger models such as twelve inches by seventeen inches to twenty four inches by thirty six inches, twenty lenticules per inch is expected to be sufficient. Larger displays could use less lenticules such as, for example, ten to fifteen lenticules per inch.

When in use, as can be seen, each spring 10 is independent and therefore the force exerted is dependent to some extent on the needs at that particular point. The force of the springs compresses the sponge between the plate 5 and the picture 4 to ensure the best possible contact between the picture 4 and the back of the lens 3.

The provision of the thick panel 24 reduces any tendency for the construction to become convex with respect to the cavity in use.

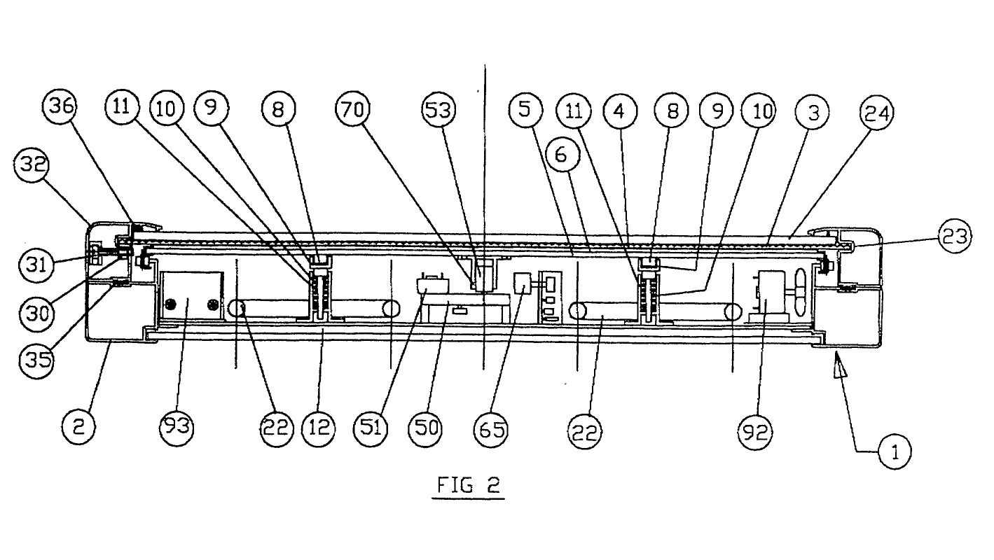

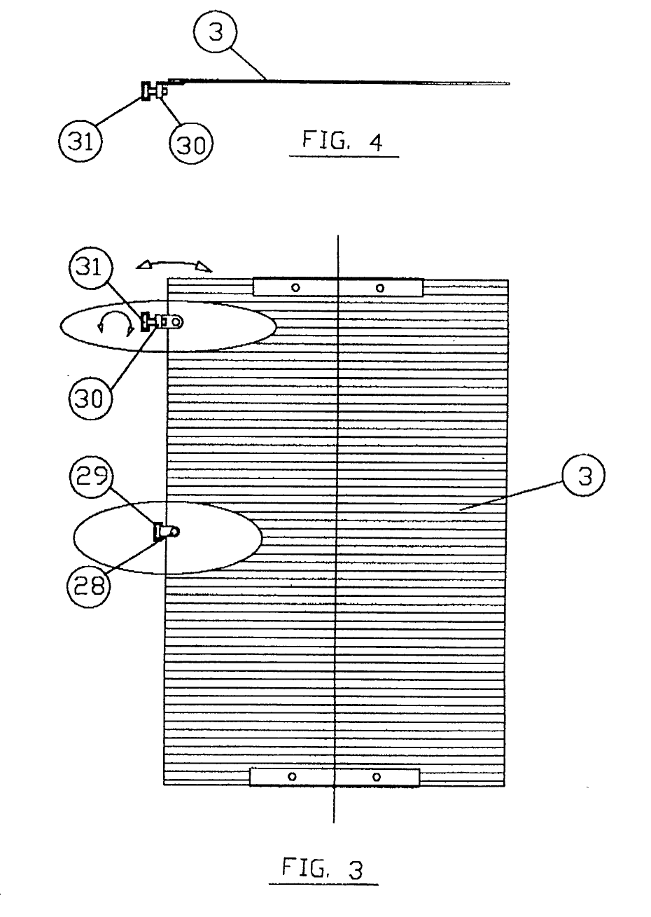

Referring now to FIG. 3 and FIG. 4, the lens 3 is mounted on a hinge pin 28. The hinge pin 28 being carried by a support member 29 which is mounted on the frame 2. The lens 3 is therefore able to rotate about the hinge pin 28. In order to obtain adjustment a bracket 30 is provided which is mounted on the lens 3. A rotatable knob 31 is provided which is threaded and passes through an aperture in the bracket 30. The knob 31 is held against rotation by engagement with a suitable position such as the surrounding frame 2.

The adjustment which is preferably able to be manipulated from the exterior of the cavity may be contained within a removable cover plate 32 which engages the main part of the frame 2 being sealed, for example, by sealing members 35 and 36 which may be formed, for example, of silicone rubber.

The adjustment enables rotational registration of the picture 4 and the lens 3, that is to say substantial parallelism between the picture 4 and lens 3 is able to be obtained. The effect of this is shown in FIG. 5 where the left-hand picture shows an image where rotational registration is inaccurate and the right-hand picture shows the same image when the rotational registration is corrected.

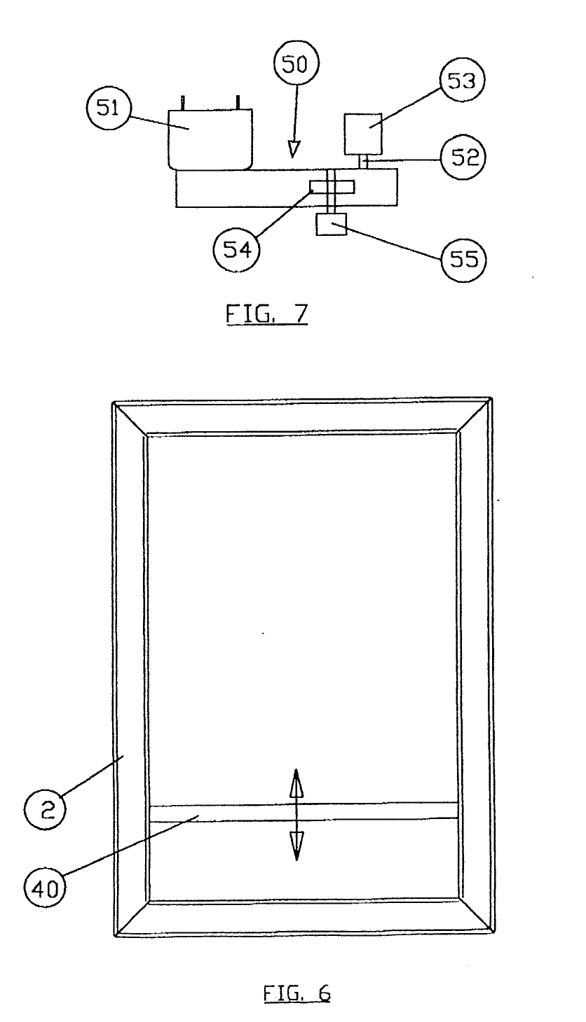

FIG. 6 shows a device that covers a group of black lines. This cover plate 40 is able to be moved in slots provided in the frame 2 to adjust the registration between the picture 4 and the lens 3 translationally. The cover 40 is moved to slide along the slots provided and is able to be held in position by rotation in the slot. After the adjustment is made it is moved to cover the black lines and a small dimple (not shown) is made on the cover plate 40 and this dimple is within the slot in the frame so that the cover plate will hold its position in use.

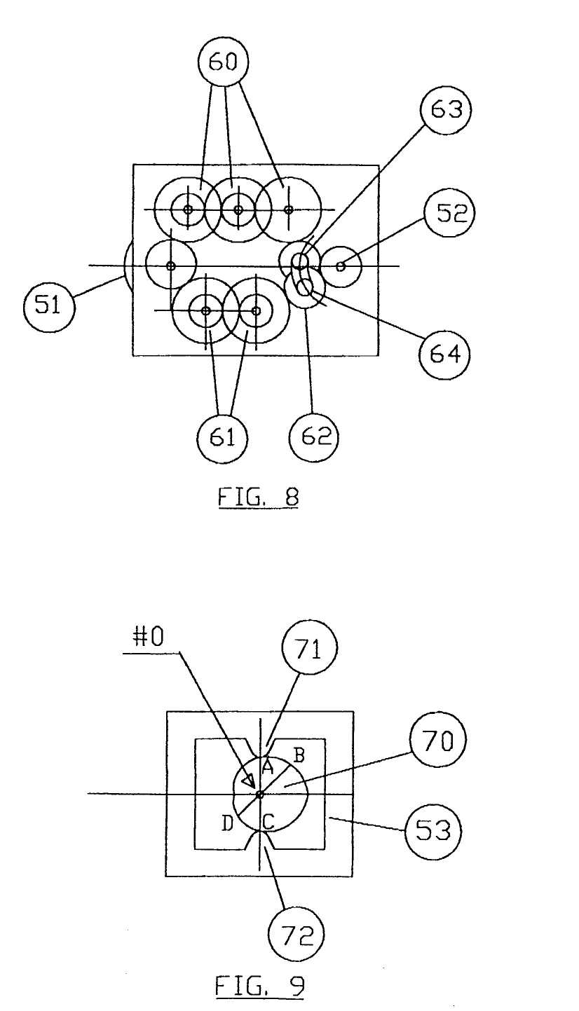

FIG. 7 illustrates a driving mechanism. The driving mechanism 50 provides a motor 51 which in use is intended to continuously rotate when a suitable driving signal is received. Two sets of stepping gears are provided to reduce the rotational speed of the driving shaft 52 which shaft drives a cam 53. A shifting gear 54 is provided which is able to be adjusted by means of a member 55 which is able to be manually engaged. This is more completely described in FIG. 8 which shows two gear groups 60 and 61. The gear groups 60 may, for example, step down the driving shaft speed to, for example, between four and eight seconds to complete a revolution and the gear chain 61 may achieve a reduction, for example, of about sixteen to thirty-two seconds a turn. The speed is controlled of course by the speed of the motor in association with a suitable electronic control device 65. The electronic control unit 65 has three main parts. The first part is a pulse generator. The pulse generator has a fixed capacitor and a variable resistor (VR). By tuning the VR, the pulse frequency is changed. The higher the resistance, the lower the frequency. The pulses enter into the second part which has a timer IC to control the duration of the pulses. The regulated pulses enter the power switch of the unit. When the pulse is given, the power source is on and the motor runs while the power source is on. When the pulse passes the power is off, and the motor slows down but is not stopped due to its own inertia. Before it stops, a further pulse is given and the motor starts to accelerate again. The higher the frequency of the impulse, the longer the acceleration, eventually the motor runs faster, and vice versa. Further the speed achieved by the gear chain 60 and the speed of the gear chain 61 is changed by an intermediate cog or roller in the gear chain 62 which is able to be positioned between a low gear position 63 and a high gear position 64 by means of operating the shifting device 55. The cam 53 is designed to give a linear displacement of, for example, four to six lenticules of the lens to the picture upon one full turn of the cam. Since the cam is connected to the driving shaft 52 that is turning at a speed of four to thirty-two seconds per turn, the picture 4 is able to move at a speed from two-thirds to eight seconds per lenticule. A cam follower 70 is provided which surrounds the cam 53 as shown in FIG. 9. The cam follower is attached to the plate 5. The cam follower provides two tips 71 and 72 which contact the cam 53 in opposite positions. As shown in FIG. 9 the diagonal distance through the moving centre point #0 is constant around the perimeter of the cam. When the cam turns from position “A” to position “B” tip 71 of the cam follower is moved forward the distance determined by the parameters of the construction. However when the cam moves from position “C” to position “D” the tip 72 is moved so as to return the cam follower to its initial position. As the cam 53 pushes the cam follow 70, and the cam follower 70 is firmly attached to the sliding plate 5, the picture is able to be driven up and down or left and right at a constant speed.

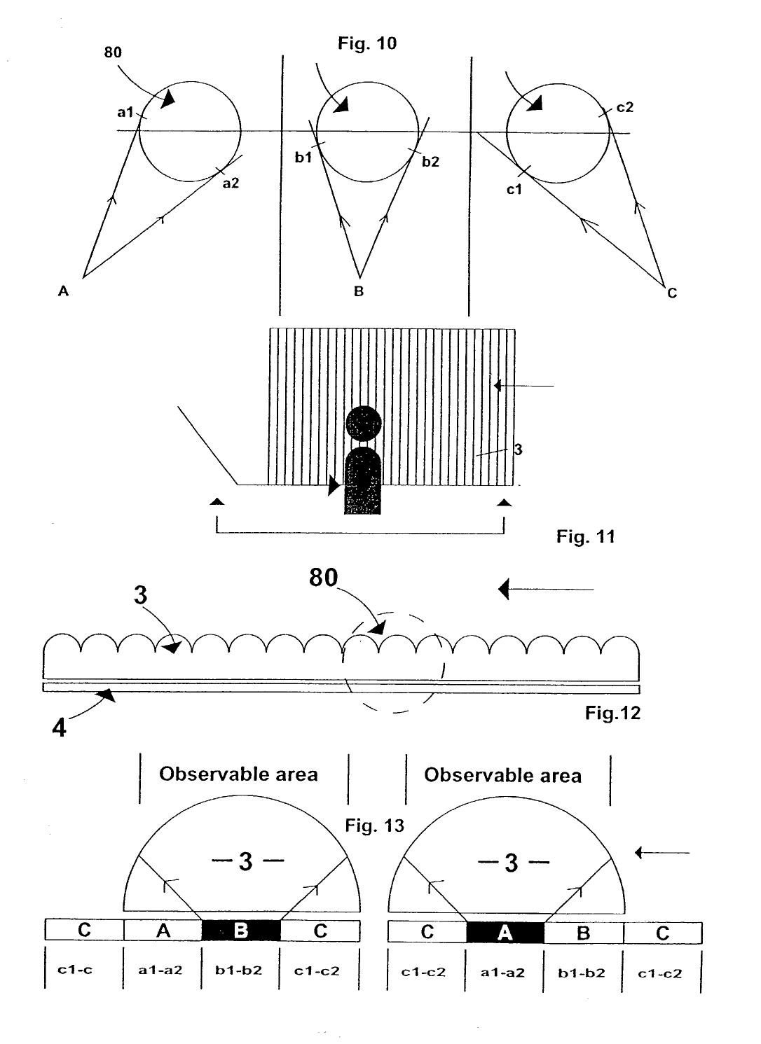

Referring now to FIGS. 10 to 13, a horizontally moving lenticular lens 3 is provided, the lenticules running vertically.

An image to be represented is indicated at 80, images of the picture being taken at positions “A”, “B” and “C” in FIG. 10. Thus an image between the positions “a1” and “a2” is taken from position “A” between “b1” and “b2” from position “B” and “c1” and “c2” from position “C”. When these are correctly positioned on the display member 4 the effect is shown in FIG. 13. In the left-hand position the lenticule 3′ is shown at the position of the image containing, for example, the picture taken from the position “B” in FIG. 10. Thus “b1” to “b2” of the image is seen. When the picture has moved so that the lenticule 3′ is, for example, at position “A” as shown in FIG. 13, then the image is represented as seen from position “A” in FIG. 10. By suitably shaping the lenticule a substantial number of successive images can be obtained. It is possible to achieve at least twelve consecutive images. The images appear to be in three dimensions because of the different angles on the lenses.

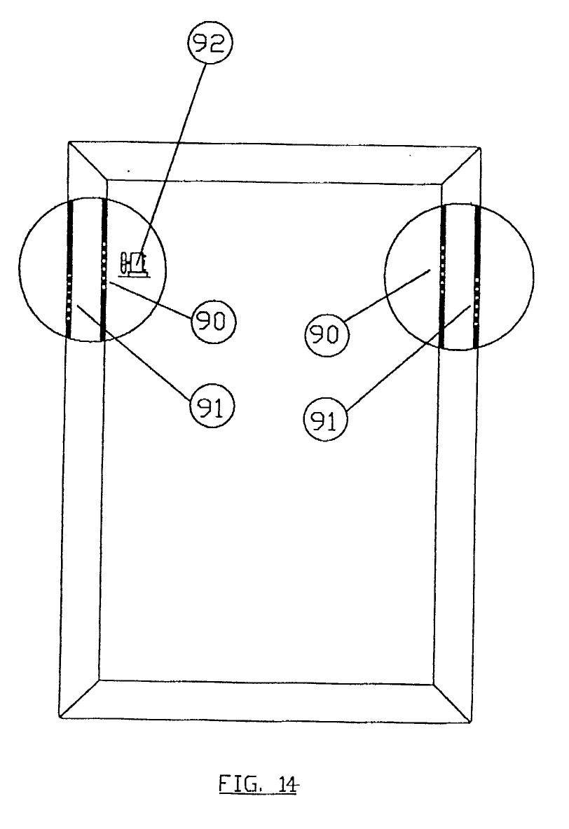

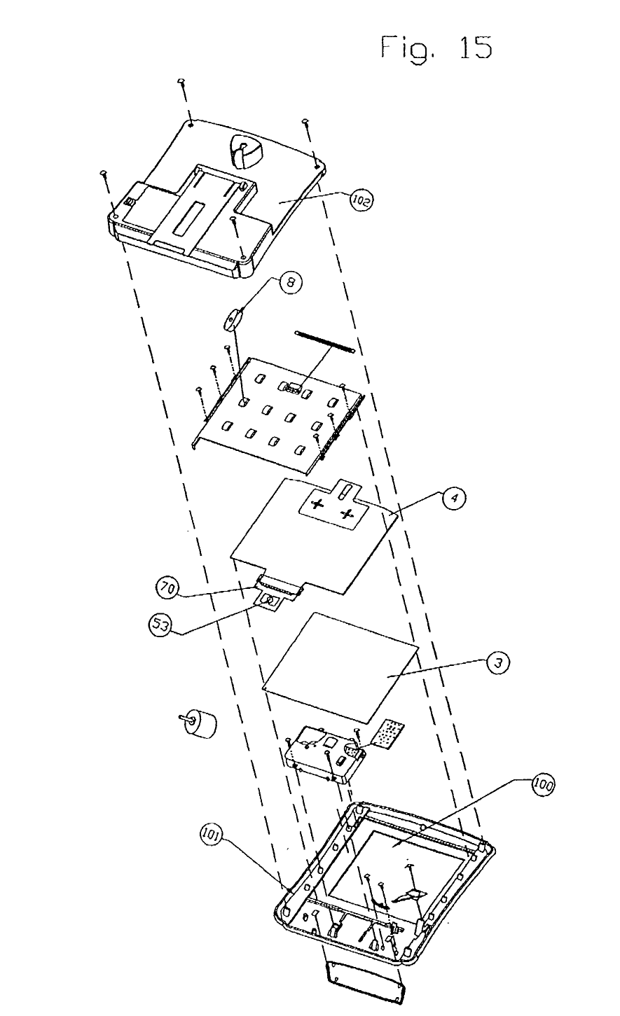

Referring to FIG. 14, in order to make the construction substantially weatherproof the silicone seals, previously described, are used. However it is desirable to move air through the construction and this can be achieved by forming venting holes 90 on the inner part of the frame and venting holes 91 on the outer part of the frame, these holes not being in register and preferably the outer holes 91 being lower positioned so that air can move but rain is substantially prevented at least from getting through the inner venting holes 90. A fan 92 may be provided to move air which, in particular, aids cooling and therefore is arranged to turn on once the light in 22 is turned on.

Referring now to FIG. 15 a simplified structure is shown. In this simplified structure, which is intended to be a small unit for indoor use, it is possible to delete the cooling fan 92, the lighting 22, transformer 93 and also the sliding plate 5. Also the various seals are able to be removed. It is intended that the device is battery operated.

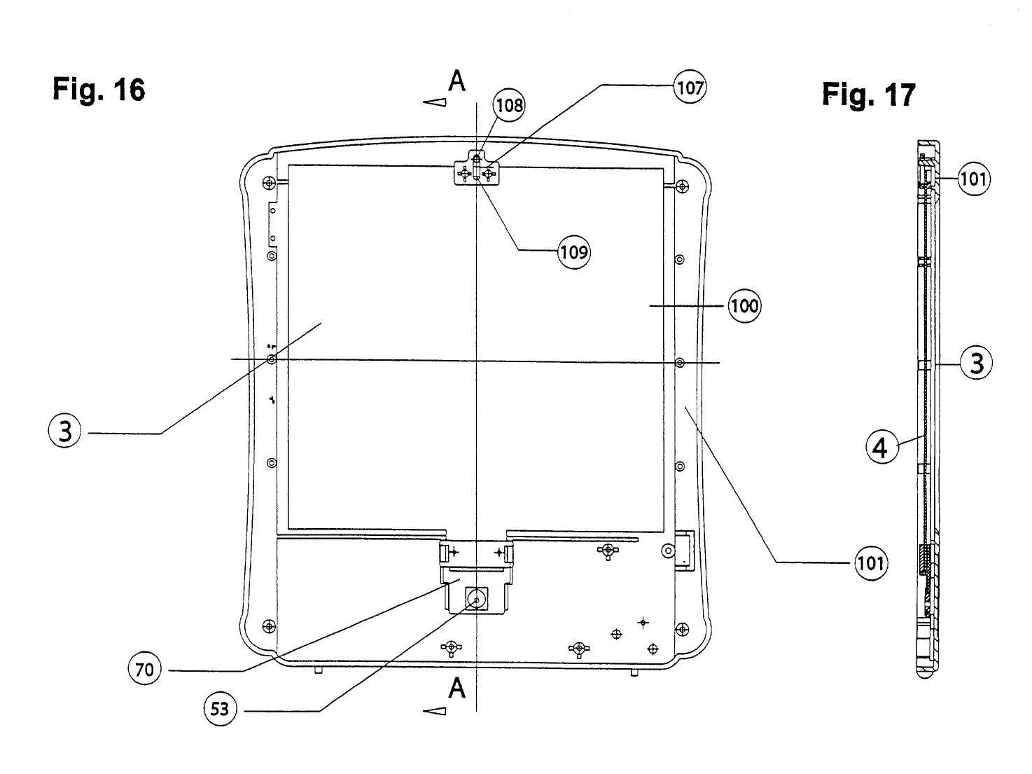

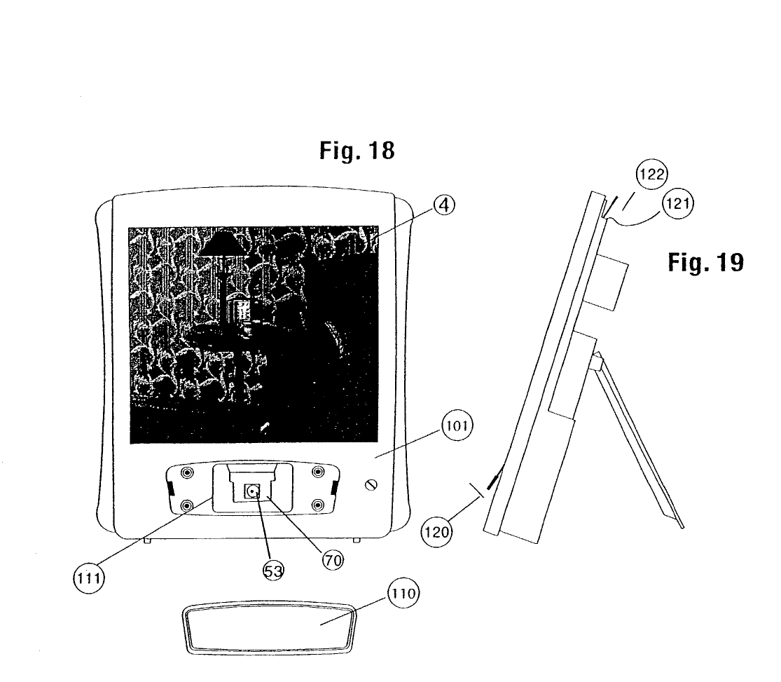

As the picture 4 is lighter it is however stiff enough and can be driven by the mechanism directly. In this construction the rollers 8 are able to bear directly on the picture for itself. The lenticular lens 3 is visible through aperture 100 in the frame which comprises a front frame unit 101 and a rear frame unit 102, able to be engaged one with the other. The cam follower part 70 is mounted directly onto the picture so that cam 53 which operates in substantially the same manner as before between the tips provided in the cam follower drives the picture 4 directly. FIG. 16 shows the picture moving mechanism of this display unit. The cam 53 drives the cam follower 70 which essentially replaces the cam follower and sliding bed of the earlier described construction. The picture is constrained by a pair of guiding racks so as to give the required register as the picture moves. A guiding sleeve 107 is provided. The sleeve 107 is guided by a pin 108 which runs in a slot 109 in the plate 107. The gap between the picture carrying plate 107 and the guiding racks is less than 0.005 of an inch as well as the gap between the guiding sleeve and the guiding pin. This enables satisfactory control to cause parallel movement of the picture responding to the pushing of the cam.

A cover plate 110 is provided to cover aperture 111 in the frame part 101 so as to provide access to the cam 53. By removing the cover plate 101 the cam follower 70 can be released from the cam as indicated in FIG. 19 by arrow 120 so that the picture can be removed upwardly through a slot at 121 in the direction 122 to allow the picture to be replaced.

In use a picture is formed substantially as shown in FIGS. 10 to 13 and mounted as the display member in either of the embodiments described. Operation of the cam and cam follower causes the picture to move relative to the lens thereby causing the illusion at least of movement of the image, as described in FIGS. 10 to 13.

The display unit described provides for high quality consecutive image display and is able to provide a relatively low cost display unit for advertising and promotion showing a short smooth moving picture. A substantially continuous running motor is provided to drive the picture, rather than a step motor as in the currently available constructions. The invention allows a display unit to show consecutive images in a widely varying speed to give a measure of natural appearance to be achieved. The display unit also enables illustrations to be substantially in a 3D manner because of the multiple views that are able to be provided. This provides a simple and economic device to demonstrate an object in a perspective with multiple views for advertising, promotion and educational use. The display unit can also be used outdoors, displaying the multiple images and short videos because of the weatherproofing features included in the preferred embodiment.

What is claimed is:

1. A display unit for displaying at least two consecutive images to be viewed by a viewer, said unit comprising:
a housing having at least two wall portions defining a cavity therebetween, at least part of one of said wall portions being made of an array of linear lenses having a lenticular front face and a flat rear face;
at least one carrier within the cavity, the carrier being able to receive in use a substantially planar display member,
and pressure means to urge the display member against the lens when a display member is within the cavity.

2. A display unit as claimed in claim 1, wherein the pressure means includes a plurality of rollers and biasing means to bias the rollers such that the display member is urged against the lens.

3. A display unit as claimed in claim 2, wherein the pressure members bear on the display member.

4. A display unit as claimed in claim 2, further including a plate is provided within the cavity, the pressure member bearing on the plate which in turn bears on the display member.

5. A display unit as claimed in claim 3, further including a substantially transparent support sheet positioned substantially against the face of the lenticular lens outward facing with respect to the housing.

6. A display unit as claimed in claim 1, wherein the lenticules in the lenticular lens provide at least 15 lenticules per inch.

7. A display unit as claimed in claim 6 having at least 20 lenticules per inch.

8. A display unit as claimed in claim 7 having at least 30 lenticules per inch.

9. A display unit as claimed in claim 1 further including adjustment means to enable the lens to be moved relative to the display member.

10. A display unit as claimed in claim 9, wherein the adjustment means is operable from outside the casing.

11. A display unit as claimed in claim 9, wherein the adjustment means includes a pivot on which the lens is mounted and the adjustment means is operable to rotate the lens about the pivot.

12. A display unit as claimed in claim 1 further including movement means operable to cause relative movement substantially in their planes between the lens and the display member.

13. A display unit as claimed in claim 12, wherein guiding means are provided to maintain the lens and display member in a substantially parallel relationship during relative movement of the lens and display member.

14. A display unit as claimed in claim 1, wherein the movement means includes a motor, and control means being provided to adjust the speed of the motor.

15. A display unit as claimed in claim 1 further including adjustment means to enable substantial parallelism between the display member and the lens.

16. A display unit as claimed in claim 1, wherein up to twelve consecutive images can be seen.

17. A display unit as claimed in claim 1, wherein the viewed images appear to be in three dimensions.
